(19) United States
(12) Patent Application Publication
(10) Pub. No.: US 2019/0124501 A1
(43) Pub. Date: Apr. 25, 2019

(54) COMMUNICATION USING COLOUR ENCODED SEQUENCE OF DIGITS

(71) Applicant: MOBILE PAYMENTS & LOYALTY, S.L., Barcelona (ES)

(72) Inventors: Josep Paradells Aspas, Barcelona (ES); Daniel Campus Mur, Barcelona (ES); Laura Herrera Alloza, Barcelona (ES); Jonathan M. Hayes, Barcelona (ES)

(21) Appl. No.: 16/098,412

(22) PCT Filed: May 3, 2016
(86) PCT No.: PCT/EP2016/059943

§ 371 Date: Nov. 1, 2018

(51) Int. Cl. H04W 12/00; H04L 29/06; G06Q 20/20; G06Q 20/18; G06Q 20/32; G06K 7/14; H04W 76/10

(52) U.S. Cl. CPC H04W 12/0013; H04W 12/003; H04L 63/0428; G06Q 20/204; H04W 4/80; G06Q 20/3274; G06Q 20/3278; G06K 7/1447; H04W 76/10; G06Q 20/18

(57) ABSTRACT

Secure communications using colour encoded messages are disclosed. Mobile devices may prepare colour encoded sequences to be displayed at and read by photo-receptor devices. Once the messages are decoded, the mobile devices may establish authorized access to a secured environment, they may secure Bluetooth connections with the photo-receptor devices. The secure Bluetooth connection may then facilitate access or vending of services or products.

The present disclosure relates to secure communications and more specifically to secure communications using colour encoded sequence of digits.

### BACKGROUND

Secure transmission of data is a necessary requirement in multiple scenarios whereby an authenticated user sends sensitive information, such as that relating to identity, payment or certain access privileges. Authentication involves a method of computer access control which a user can pass by successfully presenting several separate authentication stages. A three-form factor authentication may be implemented by users based on: (i) Inherence, that is, who the user is, e.g. based on a biometric identifier such as a fingerprint, iris scan, facial pattern or voice mark etc., (ii) Knowledge, what the user knows, e.g. password, PIN etc. and (iii) Possession, what the user has, e.g. a registered device in their possession.

Security of the data transmitted may be breached immediately following the authentication process given that existing methods mean it is possible for unauthorized individuals, e.g. third parties, to have access to the credentials presented. For example, (NFC) Near Field Communication technology broadcasts information such as credit card details at a POS terminal or other information such as personal data, it is possible to accidentally disclose the data which can be collected by “sniffer” devices. Further, the secure transmission of data must be universally possible from any standard smartphone, regardless of whether it possesses NFC, utilizing the features native to such mobile device.

It would be desirable to provide devices and methods that at least partially solve the aforementioned problems.

### SUMMARY

In a first aspect a method of securely communicating a colour encoded sequence of digits from a display of a mobile device to a photo-receptor device is disclosed. The method comprises preparing the colour encoded sequence of digits at the mobile device. The sequence of digits may comprise a dynamic token with information to identify the mobile device to the photo-receptor device. Proximity of the photo-receptor device is then identified. The colour encoded sequence of digits is then presented to the photo-receptor device. The sequence of colour-encoded digits may be displayed in the form of light flashes on the screen of the mobile device. Then, confirmation of reception of the colour encoded sequence of digits at the photo-receptor device is received. Then, confirmation of decoding of the sequence of digits at the photo-receptor device is received. By identifying proximity before the sequence of digits encoded as flashes of coloured light is displayed on the mobile screen, it is possible to ensure a secure transmission of the sequence of coloured light digits to the photo-receptor device as the sequence of digits does not appear on the display until the mobile device is correctly positioned. The sequence of digits may be displayed in a colour encoded format at the display when it is confirmed that the display is in the photo-receptor device's proximity. This may ensure that the sequence of digits is not compromised during its transmission to the photo-receptor device. The information is transmitted as a coloured light signal, which, when entering contact with ambient light, dissipates and therefore it is not possible for it to be captured by a third party.

In some examples, the method may further comprise initiating a pairing connection between the mobile device and the photo-receptor device once the decoding is successful. The pairing connection may be a wireless connection, such as a Bluetooth or a Wi-Fi connection, or a cable connection, e.g. via a USB cable. The pairing connection may only be initiated when the sequence of digits has been successfully decoded. Information in the decoded sequence of digits may then be used for initiating the pairing connection. This may ensure a secure connection between the mobile device and the photo-receptor device.

In some examples the pairing may further comprise actuating on an access module once the decoding takes place. The access module may be a structure, such as a lock, controlling access to an enclosed space or to a parking space. The enclosed space may be a room, a building or a safe.

In some examples the method may further comprise performing a transaction once the pairing is successful. The photo-receptor device may be a vending device. The mobile device may send a request and the photo-receptor device may receive the request to release a product or a service. A secure communication may then be facilitated by the mobile device and between the photo-receptor device and a third party financial entity to confirm that the request is a valid request. For example, that an account associated with the mobile device has enough funds to cover the cost of requested product or service. When the request is validated, the product or service may be released and a confirmation may be sent to the mobile device.

In some examples, the communication between the photo-receptor device and the third party financial entity may be implemented through the paired mobile phone. As the mobile device is a trusted device, the communication may be considered a secure communication.

In some examples the vending device may be a full-line vending device, such as a beverage device. In one implementation, the discharge of the beverage may be initiated after the sequence of digits is decoded. This may be the case when the beverages are provided free of charge to certain users of the device, such as employees in a company. In other implementations, a communication initiated by the photo-receptor device and the third party financial entity may allow for the beverage device to discharge the beverage once an amount corresponding to the beverage is transferred from an account of the user to the machine of the vendor.

In some examples, the photo-receptor device may be a parking metering device. The user may want to access or occupy a parking space for a limited amount of time. Once the sequence of digits is decoded, the parking metering device may initiate a counter either directly or through a communication with a central station to set, e.g. the starting time of the parking space occupation. When the user wants to release the occupied parking space, he may indicate so with a second sequence of digits, that may be similar to the first sequence of digits, to identify the account holder to the parking meter device. The parking meter device, either directly or through a communication to the central station, may then calculate the parking fee. Another communication of the parking metering device may complete the transaction with the transfer of the corresponding fee from a payment account associated with the user.

In some examples, initiating a transaction may comprise requesting authorisation for a transaction based on said decoded sequence of digits, requesting verification of the transaction at the mobile device, and finalising the transaction.

In some examples, to prepare a colour encoded sequence of digits, at least part of the sequence of digits may be requested from a trusted third party. The trusted third party may be a financial institution, licensed E-Money organization or authorizing co-signatory. The requested sequence of digits may then be received at the mobile device. Then, the sequence of digits may be encoded in a colour coded format.

In some examples, requesting a sequence of digits from a trusted third party may comprise preparing a message comprising at least an identifier of the mobile device and an indicator associated with the photo-receptor device and transmitting the prepared message to the trusted third party. The indicator may comprise a monetary value for a product or service offered by the photo-receptor device.

In some examples, confirming that the mobile device is placed against the photo-receptor device may comprise receiving a signal from one or more sensors of the mobile device. The one or more sensors may be one or more of an accelerometer, a proximity sensor, a magnetometer, an orientation sensor and a light intensity sensor. For example, the light intensity sensor may provide a low light intensity signal, indicating that the sensor is covered or that the mobile device is placed against a flat surface. Then the accelerometer may sense that the device is not moving. The magnetometer and/or the proximity sensor may sense that, e.g. an object, such as a metallic object, may be in contact with the mobile device. The orientation sensor may indicate that the device is oriented appropriately when placed against the photo-receptor device. The combination of some or all of the signals may provide enough certainty that the device is placed against the photo-receptor device, or at least that the display may not transmit light inappropriately.

In some examples, displaying the sequence of digits in a colour encoded format at a display of the mobile device may comprise displaying one or more sequences of one or more colours at one or more predetermined areas of the display. The number of sequences and colours may depend on the amount of information required to be transmitted, the time that the communication may require, the size of the device, the flashing rate of the display and the reading rate of the photo-receptors. In the simplest implementation, one sequence of one colour at a time may be displayed. The sequence may implement a series of on-off lights that can be directly understood by the photo-receptor device. In another implementation, one sequence of a plurality of colours may be displayed. Each colour of the sequence may represent a character or a string. In yet another implementation, a plurality of sequences of a plurality of colours, respectively, may be displayed. Each sequence may be implemented at a separate area of the display. The encoded may be implemented not only by the colours of the sequences but also by the position of the colour, i.e. the sequence to which the colour belongs.

The one or more colours may occupy a predetermined area of the display, e.g. an area close to a corner of the display, so that it may be easier to align with the photo-receptors.

In some examples, decoding the sequence of digits may comprise identifying the one or more sequences of one or more colours, comparing the identified sequences of colours with stored reference sequences of colours and translating the identified sequences of colours based on the stored reference sequences of colours. The photo-receptor device may comprise a memory to store the reference sequences and/or colours.

In some examples, the photo-receptor device may actuate on the display to determine the area of the display where the one or more colours are displayed. The photo-receptor device may comprise one or more finger-like actuators that may tap on the display to define an area of haptic response on the display. The mobile device may, in response to said tapping display the sequence of digits in the area defined by the actuators. This may allow the sequence of digits to be aligned with the photo-receptors so that the sequence of digits may be read by the photo-receptor device.

In some examples, reading the colour encoded sequence of digits using the photo-receptor device may comprise identifying the position of the colour encoded sequence of digits and identifying a sequence of one or more colours using one or more photo receptors. The sequence of one or more colours may correspond to a coded message. The photo-receptor device may hold the key to the code in order to interpret the message.

In some examples, identifying the position of the colour encoded sequence of digits may comprise identifying the position of the mobile phone with respect to the photo-receptor device. In some implementations, this may be done by identifying placement of the mobile phone at a predetermined resting area of the photo-receptor device. Additionally, identifying the position of the mobile phone may further comprise identifying the orientation of the mobile device.

In another aspect a mobile device to communicate a colour encoded sequence of digits to a photo-receptor device is disclosed. The mobile device may comprises a communication module, a colour encoding module to receive a sequence of digits and generate a colour encoded sequence corresponding to the received sequence of digits, and a display to present the colour encoded sequence to the photo-receptor device.

In yet another aspect a photo-receptor device to receive a colour encoded sequence of digits from a mobile device is disclosed. The photo-receptor device may comprise one or more optical sensors, to receive the colour encoded sequence from the mobile device, and a decoder, to decode the colour encoded sequence and generate the sequence of bits.

In yet another aspect, a secure communication system is disclosed. The secure communication system may comprise a mobile device, according to examples disclosed herein, a photo-receptor device, to receive a product or service request from the mobile device and an authorization network, to receive an authorization request from a mobile device and authorize a user or a payment to the phot-receptor device in response.

In yet another aspect, a computing device is disclosed. The computing device may comprise a memory and a processor. The memory may store computer program instructions executable by the processor, said instructions comprising functionality to execute a method of securely communicating a colour encoded sequence of digits from a display to a photo-receptor device according to examples disclosed herein.

In yet another aspect, a computer program product is disclosed. The computer program product may comprise instructions to provoke that a computing device implements a method of securely communicating a colour encoded sequence of digits from a display to a photo-receptor device according to examples disclosed herein.

The computer program product may be embodied on a storage medium (for example, a CD-ROM, a DVD, a USB drive, on a computer memory, cloud-based storage unit or on a read-only memory) or carried on a carrier signal (for example, on an electrical or optical carrier signal).

The computer program may be in the form of source code, object code, a code intermediate source and object code such as in partially compiled form, or in any other form suitable for use in the implementation of the method. The carrier may be any entity or device capable of carrying the computer program.

For example, the carrier may comprise a storage medium, such as a ROM, for example a CD ROM or a semiconductor ROM, or a magnetic recording medium, for example a hard disk. Further, the carrier may be a transmissible carrier such as an electrical or optical signal, which may be conveyed via electrical or optical cable or by radio or other means.

When the computer program is embodied in a signal that may be conveyed directly by a cable or other device or means, the carrier may be constituted by such cable or other device or means.

Alternatively, the carrier may be an integrated circuit in which the computer program is embedded, the integrated circuit being adapted for performing, or for use in the performance of, the relevant methods.

### BRIEF DESCRIPTION OF THE DRAWINGS

Particular embodiments of the present invention will be described in the following by way of non-limiting examples, with reference to the appended drawings, in which:

FIG. 1 shows a flow chart of a method of securely communicating a sequence of digits encoded as coloured light to a photo-receptor device, according to an example;

FIG. 2 illustrates an example method of pairing using a colour coded sequence of digits;

FIG. 3 schematically illustrates a system for secure communication using a colour coded sequence of digits, according to an example.

### DETAILED DESCRIPTION OF EMBODIMENTS

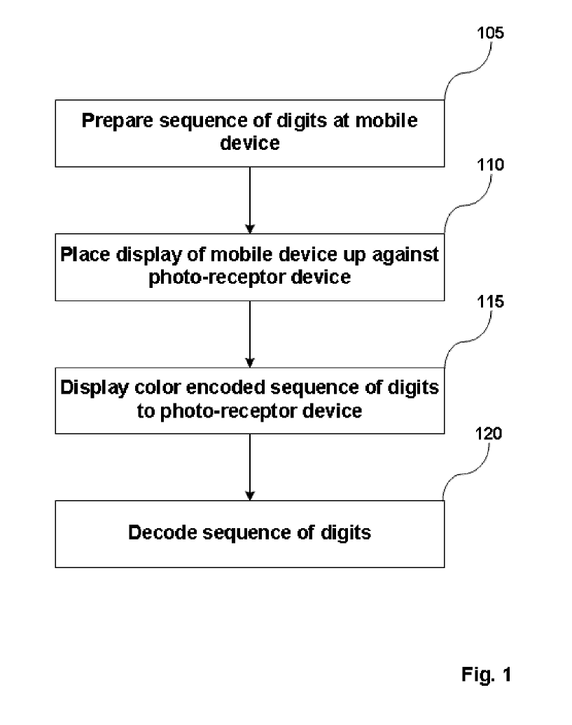

FIG. 1 shows a flow chart of a method of securely communicating a sequence of digits to a photo-receptor device, according to an example. In block 105 a sequence of digits is prepared at a mobile device (e.g. a smartphone). The sequence of digits may comprise identification information of the device and/or of the owner of the device and it may also comprise information related to a transaction. This information may comprise an amount corresponding to available funds or credit in an account belonging to the user. It may also comprise information about a product or a service the user wishes to acquire. The sequence of digits may be a text string. The sequence of digits may be prepared by the mobile device based on information already present at the mobile device or based on information received from a remote secure location through a communication link. Alternatively, part or the entire sequence of digits may be prepared at the remote secure location based on a user request and transmitted to the mobile device via the communication link. The sequence of digits may then be encoded at the mobile device in a colour coded format.

In block 110, the display of the mobile device may be placed up against the photo-receptor device. The photo-receptor device may comprise one or more light sensors configured to detect one or more light or light sequences emitted by the display of the mobile device. The light or light sequences may be in one or more colours and the photo-receptor device may be configured to distinguish between the one or more colours. The mobile device may be configured to identify correct placement of the display up against the one or more light sensors of the photo-receptor device. For example, the mobile device may identify correct placement based on one or more signals received by one or more mobile device sensors, respectively. Accordingly, the photo-receptor device may comprise visual or physical patterns to facilitate correct placement of the display up against the photo-receptor device.

In block 115, once the display is placed correctly up against the photo-receptor device, the mobile device may begin displaying the light or colour sequence. Each light or colour and each sequence of lights or colours may correspond to an encoded signal. For example, each light or colour sequence may correspond to a sequence of bits, bytes or characters.

In block 120, the photo-receptor device may decode the sequence of digits once the light or colour sequence is completed. The decoded signal may correspond to the sequence of digits prepared at the mobile device.

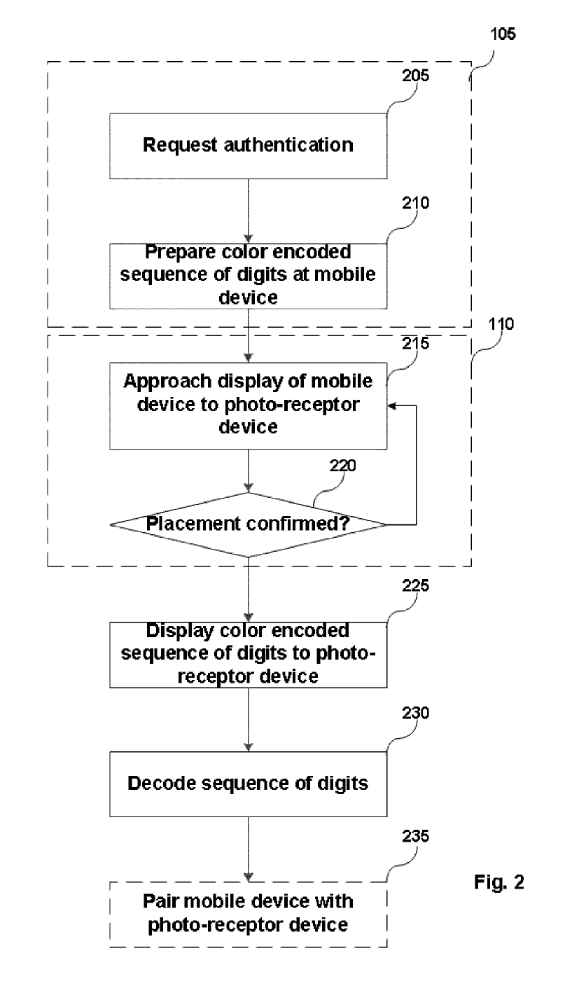

FIG. 2 illustrates an example method of pairing using a colour coded sequence of digits. A mobile device may wish to pair with a photo-receptor device, e.g. a vending device. In block 205 an authentication is requested from a remote secure source. A user may send a request from a user device to the remote secure source. The request may include information about the user, the user device and/or a transaction the user wishes to perform. For example, the user may wish to present the sequence of digits at a vending machine. The vending machine may be appropriately equipped to read and decode the sequence of digits. The remote secure source may be a trusted third party that may validate the user request and prepare the authentication. Then a sequence of digits may be prepared that may include part or all of the information included in the request as well as information related to the user device (e.g. MAC address, operating system etc.). For example, if the user wishes to purchase a product or a service, the colour encoded sequence of digits may comprise data representing the value of the product or service the user wishes to purchase. In block 210, the mobile device may process the sequence of digits and prepare it as a colour encoded sequence of digits. In case the sequence of digits is in the raw un-encoded format, preparing the sequence of digits may comprise encoding the text string in one or more sequences of one or more colours. Optionally, the text string may be encrypted using any known encryption technique prior to being encoded in the colour encoded format. If the sequence of digits is already encrypted (e.g. by an app at the mobile device) then the mobile device may either encode the encrypted sequence of digits directly in the colour encoded format or decrypt it and encode the decrypted message in the colour encoded format. This may depend on assumed decryption capabilities of the photo-receptor device and the level of security intended. For example, if a high level of security is intended, the sequence of digits may remain encrypted until it is decoded and decrypted at the photo-receptor device. When the sequence of digits is prepared in a colour encoded format it may be considered ready to be displayed at a display of the mobile device. However, as the displayed sequence of digits may be apprehended by an onlooker, the mobile device may withhold the display of the sequence of digits until the display is placed up against the photo receptors of the photo-receptor device. If the mobile device is placed with the screen of its display in contact with the photo-receptor device, i.e. with its display facing against the photo receptors, it may not be possible for shoulder surfers to capture the colour encoded light sequence and the communication of the sequence of digits from the mobile device to the photo-receptor device may be considered secure. The mobile device may, therefore, display the colour encoded sequence only when it has ensured that the display is not in common view, and is within proximity of the receiving photo-receptor. In block 215, the display of the mobile device may be approached to the photo-receptor device. The mobile device may recognize the movement by signals issued by various sensors of the mobile device. For example, an accelerometer sensor may sense acceleration at first and deceleration at last after the user has instructed the device to display the sequence of digits. Once the accelerometer senses no acceleration or deceleration, it may indicate that the mobile device is not moving, an indication that it may have been placed up against the photo-receptor device. However, the signal from the accelerometer alone may not be sufficient to reach that conclusion as the mobile device may indeed have been placed up against the photo-receptor device, nevertheless from the opposite side, i.e. with the display facing outwards. Therefore, a second sensor, e.g. an ambient light sensor, may be used to indicate if the side of the display is receiving light. This, combined with the measurement of the accelerometer may give a good indication that the display is not moving and facing an object. However, this may still not be sufficient to indicate that the device is up against the photo-receptor device. To improve accuracy, a third sensor, e.g. a magnetometer may be used. It may measure changes in the magnetic field and generate a signal in response. The mobile device may be configured or trained to identify the particular change of the magnetic field when the magnetometer approaches the photo-receptor device. The combination of the signals from the three sensors used in the example described above may provide a relatively safe indication that the display may have been placed up against the photo-receptors of the photo-receptor device. The combination of sensors described before is given as an example. Other combinations of sensors may be used, depending on the device configuration and the respective application. The device, in block 220, may check if a correct placement of the display up against the photo receptors has been performed. This may include a comparison of the signal values emitted from the various sensors with pre-established values stored at the mobile device. If placement is not confirmed the mobile device may inform the user with any suitable means. For example, it may emit a characteristic sound or light or it may vibrate. When placement is confirmed the mobile device may react accordingly to inform the user that it is ready to start displaying the digits encoded as a sequence of coloured light. In block 225, the mobile device may display the colour encoded sequence of digits at its display. The photo-receptor device may read the colour encoded sequence of digits and decode it in block 230. When the decoding is complete, the photo-receptor device may inform the user about the correct reception of the sequence of digits. The photo-receptor device may comprise a display for that purpose. Alternatively, it may emit a sound or simply perform the required supply of the product or service requested by the user. For example, if the purpose of the colour encoded sequence of digits communication is the acquisition of an article from a vending machine, the vending machine may simply release the article once the sequence of digits is decoded. In case the communication involves the purchase of a product or service, the sequence of digits may merely serve as identification of the user or user device to the photo-receptor device indicating the availability of funds or credit for the purchase of the product or service. Then, the photo-receptor device (vending machine) may communicate with a financial entity to complete the transaction and release the product or service. The financial entity may be the same as the trusted third party that prepared the sequence of digits. Furthermore, the communication between the vending machine and the financial entity may be performed through a communication line that may be established through the mobile device. Since the mobile device has been identified by the photo-receptor device and is considered a trusted device, a pairing process between the mobile device and the vending machine may be performed, in block 235. The pairing process may be implemented between e.g. a wireless module of the mobile device and a corresponding wireless module of the vending machine. For example, the wireless modules may be Wi-Fi, Bluetooth or similar type of wireless modules. Alternatively, the mobile device may be physically connected, e.g. with a USB cable, to the vending machine to perform the pairing process. Once the two devices are paired, the vending machine may use the mobile device as a communication device to connect to the financial entity and finalise the transaction. When the transaction is finalised, the vending machine may release the product or service requested by the user. The user may receive a confirmation of the transaction from the vendor in the form of a receipt. Additionally, the user may optionally receive a message from the financial entity requesting confirmation of the transaction that the vending machine has requested to perform at the financial entity.

As all the communications are performed through the mobile device, the transaction may be considered secure and no information about the user may be available to any shoulder surfers at the vending machine or in its proximity.

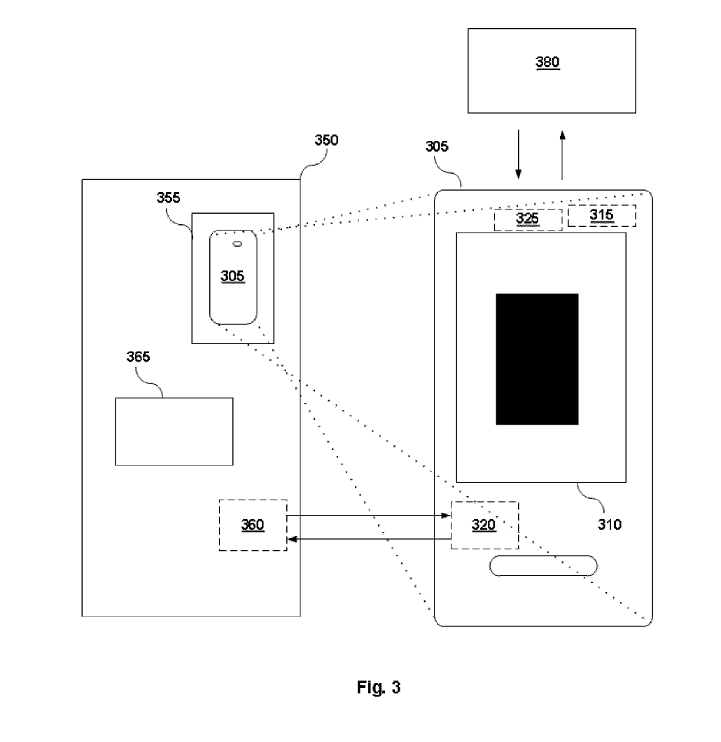

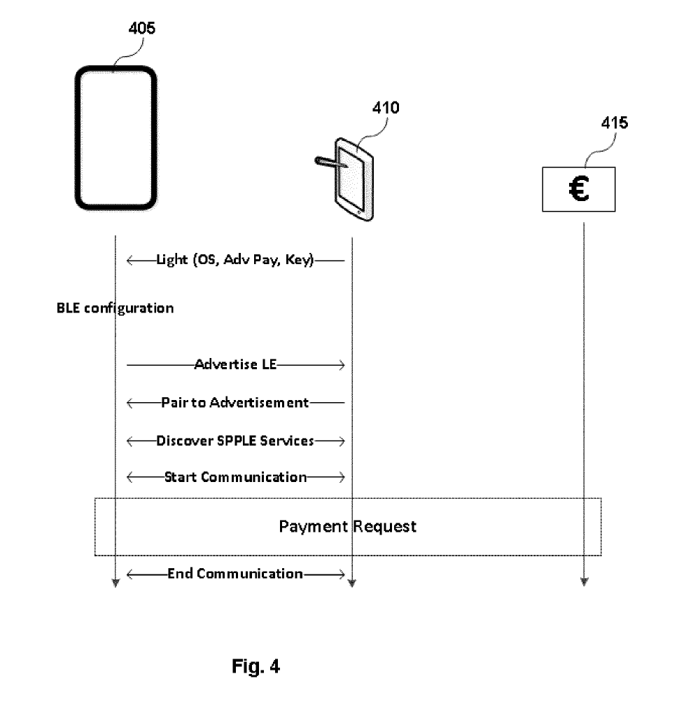

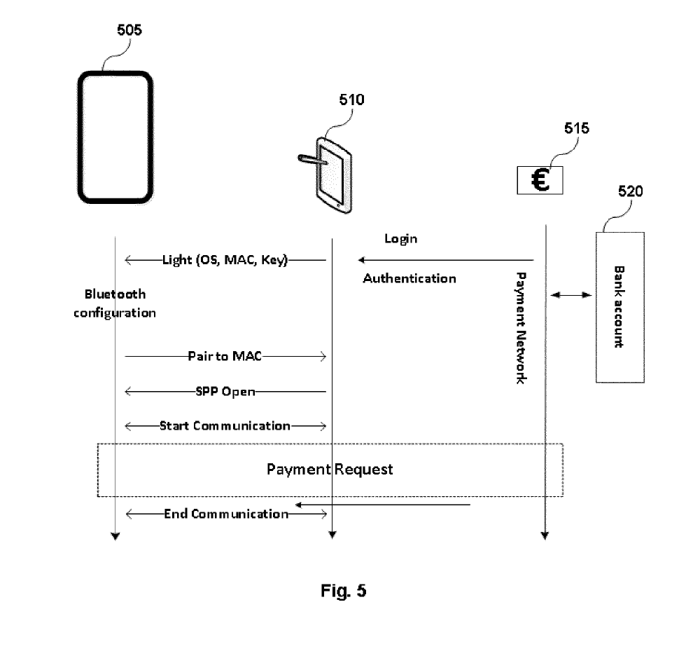

FIG. 3 schematically illustrates a system for secure communication using colour coded sequence of digits, according to an example. The system may comprise a mobile device 305, a photo-receptor device 350 and a remote trusted third party 380. The mobile device 305 may comprise a display 310, a first communication module 315 and a second communication module 320. Furthermore, the mobile device 305 may comprise a sensor module 325. The mobile device 305 may be a wireless communication device such as a mobile device, a smartphone, a tablet, a personal computer or any other mobile communication device equipped with a display and communication modules and sensors. The photo-receptor device 350 may comprise a photo-receptor module 355, a photo-receptor communication module 360 and an interaction module 365. The photo-receptor module 355 may comprise one or more photo-sensitive sensors. The photo-receptor communication module 360 may be similar to, i.e. configured to connect with, the second communication module 320 of the mobile device 305. The interaction module 365 may be an interactive display, a user interface module, an access module etc. In an example scenario, a user, e.g. the proprietor of the mobile device 305 may wish to purchase a product or service from the photo-receptor device 350. The photo-receptor device 350 may be a vending machine, e.g. an infusion machine such as a coffee machine. The mobile device 305 may be a mobile device, e.g. a smartphone. The user may approach the coffee machine and read a number corresponding to the price of the infusion, e.g. coffee, the user wishes to purchase. The price may be input to the vending machine or to the mobile device by the user or automatically, e.g. by reading a QR code at the coffee machine corresponding to the item and its price. When the price is input in the mobile device, the user may request an authorization from the remote trusted third party, e.g. from a financial entity where the user has associated funds or credit. The mobile device 305 may comprise an application (app) for sending a request message to the financial entity, requesting the authorization. The request message may include user information, for identifying the user to the financial entity, product information, such as the item to be purchased, vendor information (i.e. the proprietor of the coffee machine) and price information (i.e. the amount of the item to be purchased). The financial entity may prepare the authorization which may include some or all of the information included in the request. For example, the authorization may not include user information as the vendor need not know who the user of the mobile device is. For example, the sequence of digits may include the product information, the vendor information and a funds confirmation, i.e. that the bearer of the sequence of digits has adequate funds or credit for purchasing the requested item. A sequence of digits may then be prepared in a colour encoded format. For example, the information to be included in the sequence of digits may be translated to a sequence of colours. A sequence of colours may include one or more colours flashing at predetermined time intervals. The colour and the flashing time may correspond to a character or string of characters. For example, a white colour flashing for 10 msec may correspond to the letter A.

When the sequence of digits has been colour encoded, the user may approach the mobile device to the photo-receptor module of the coffee machine. The photo-receptor module may comprise a base or a stand so that the mobile device may rest on the photo-receptor device without the user needing to hold it. The app of the mobile device may collect sensor data from the sensor module 325 to identify when the display 310 has been placed against the photo-receptor module 355 of the coffee machine. When the correct placement identification takes place, the app may display the colour encoded sequence of digits. The photo receptor module 355 may read the colour encoded sequence of digits and decode it. It may then pair with the mobile device and initiate a communication through the mobile device with the financial entity 380 to finalise the transaction and release the item requested, i.e. the coffee. The photo-receptor communication module 360 may receive a request from the photo-receptor module 355 to pair with the second communication module 320. The pairing request may include pairing information that was included in the colour encoded sequence of digits. The photo-receptor communication module 360 may then pair with the second communication module 320. From then on, the photo-receptor device 305 may send a request to the first communication module 315 of the mobile device to establish a connection with the financial entity 380. When the connection is established, the photo-receptor device 305 may transmit a transaction request to the financial entity. The transaction request may comprise a request to transfer an amount from the funds or credit of the user associated with the received sequence of digits. Therefore, the transaction request may include at least a user identifier and a vendor identifier. When the financial entity receives the transaction request it may perform the transfer or, optionally, forward the request to the user's mobile device for confirmation before performing the transfer. Once the transfer is completed it may send a confirmation message to the photo-receptor device 350 (and optionally to the mobile device 305). The photo-receptor device 350 may receive the confirmation and may release the requested item (e.g. coffee) through the interaction module 365. When the requested item is picked-up, the photo-receptor device may unpair from the mobile device and the transaction may be considered complete.

In another example scenario, a purchase transaction is performed at a vending machine. The vending machine may provide a product or a service. For example, the vending machine may provide a product, such as a food or a beverage, or a service. For example the vending machine may be a parking meter providing a parking service. The vending machine may be provided with a photo-receptor device and a corresponding processing module set up for its product or service vending purpose, so as to comprise the functionality of the vending machine it corresponds. For example, the vending machine may have a metering module when the vending machine acts as a parking meter.

During an operation mode of an example transaction there may be three distinct phases. During the first phase a user may begin a transaction. The user may initiate the transaction from an app on the user's mobile device that may be associated to a cloud-based wallet. The cloud based wallet may be a bank wallet or any other type of wallet, for example mobile carrier operated or any other third-party.

During the second phase, authentication may take place. The user may log in to the app and may be securely authenticated by a payment network which may or may not involve Multi-Factor Authentication (i.e. a three-form factor authentication to determine if the user access is legitimate) and may complete payment in three ways:

a.—From a prepaid, stored-value balance in the user's cloud-based wallet, using any available funds from a prior top-up;
b.—By authorising the user's bank to provide the payment network with access to funds from the user's bank account (for example, an account access according to the “Access to the Account” (XS2A), in accordance with the EU Payment Services Directive (PSD2))
c.—As an instant payment transaction within the SCTIns. scheme, the European Union Single Euro Payments Area (SEPA) Credit Transfer Faster Payments Framework, whereby money is sent instantly from a bank account to a mobile number, email address or other identifier associated with the beneficiary's bank account, whereby it is deposited in the space of a few seconds.

If the vending machine is a parking meter, a timer may begin at this point (so there would be no need to collect a ticket).

The third phase may be the interaction phase. The user may select to “pay” (for example by tapping a button within the application) or open a specific tab in the wallet that may indicate the means of payment. In this case the user may select to use a digit encoded coloured light communication.

Communication between the mobile device and the vending machine may be established via a wireless protocol, such as Bluetooth. In order to set up such a communication without ambiguities, information from the mobile device (e.g. smartphone) may be transmitted to the vending machine using a sequence of coloured light generated by the mobile device's display and be received by one or several optical sensors on the vending machine.

Once the application on the mobile device is active, the user may place the display of the mobile device against the optical sensor to initiate communication. The colour sequence may automatically start transmitting once the mobile device is held in the correct position for the colour communication. In order to determine the correct position of the device, one or several additional sensors of the mobile device may be employed. For example:
An accelerometer on the mobile device may determine that the mobile device is vertically positioned
A proximity sensor on the mobile device may determine that the mobile device is in the vicinity (in the range of millimetres) to the vending machine.
A magnetometer on the mobile device may measure the magnetic field coming from a magnet located close to the optical sensor(s) and help to determine if the mobile device is close to the location of the optical sensor(s).
A haptic touch sensor, or an “artificial finger” contact, on the vending machine, when in contact with the display of the mobile device, may confirm the close proximity of the mobile device to the vending machine and helps the mobile device to figure out the position of the optical sensor.

These sensors may be used individually or together, in a cooperative manner, with a positive result.

When the app on the mobile identifies the mobile device in the correct position it may automatically start transmitting data to the vending machine reader as a sequence of changing colours. The vending machine may be waiting for a certain pattern of colours as a start sequence to begin decoding colours.

An example set of colours may be described in the following table:

TABLE 1
R, G and B stands for the basic colours Red, Green and Blue
respectively. 0 means no contribution and 255 maximum contribution.

| | R | G | B |
|---|---|---|---|
| Black | 0 | 0 | 0 |
| Blue | 0 | 0 | 255 |
| Green | 0 | 255 | 0 |
| Cyan | 0 | 255 | 255 |
| Red | 255 | 0 | 0 |
| Magenta | 255 | 0 | 255 |
| Yellow | 255 | 255 | 0 |
| White | 255 | 255 | 255 |

As a total of eight colours may be defined in the example, encoding may be implemented in octal according to the following example digit assignment:

TABLE 2
Encoding in octal of different colours

| Colour | Number |
|---|---|
| Blue | 0 |
| Green | 1 |
| Cyan | 2 |
| Red | 3 |
| Magenta | 4 |
| Yellow | 5 |
| White | 6 |
| Black | 7 |

In the example implementation, the colours white and black may be used as control digits. Therefore they may not be used for data encoding. As a result, only six colours may be available. With these 6 colours encoding in hexadecimal encoded data may be used, according to the example. The mapping between sextal (i.e. the octal encoding minus the 2 colours not used for encoding) and hexadecimal is the following:

TABLE 3
Encoding of hexadecimal data with colours

| Hexadecimal | Sextal |
|---|---|
| 0 | 34 |
| 1 | 01 |
| 2 | 02 |
| 3 | 03 |
| 4 | 04 |
| 5 | 05 |
| 6 | 10 |
| 7 | 12 |
| 8 | 13 |
| 9 | 14 |
| A | 15 |
| B | 20 |
| C | 21 |
| D | 23 |
| E | 24 |
| F | 25 |

As the timing on the mobile device may not be accurate it may result in an uncertainty for the optical reader to differentiate from one single digit to two digits when colours are repeated. So the repetition of colours may be avoided in the transmission. Two example techniques may be used at the same time: One on the coding and another on the transmission. The first technique may be applied during coding. In table 3 it can be seen that the hexadecimal digits 0, 7 and D may be coded with 34, 12 and 23, instead of 00, 11 and 22 (which would be the logical encoding according to the other values on the table). The other technique used may be applied during transmission. When data is transmitted a control code (for example the colour white) may be used to separate equal colours. For example if 1 and 6 are to be transmitted consecutively, instead of the colours 01 and 10 that may result with two consecutive 1s, the colour sequence to be used may be 01610. That is, a white colour may be transmitted between two green colours.

According to the example encoding rules presented above, a sequence of two values, such as 0x1 0xbcf5bc87, may be encoded as:

01 20 21 25 05 20 21 13 12.

But the sequence of colours transmitted may be:

01 20 21 25 05 20 21 6 13 12
where the colour six (white) is used to separate the two consecutive 1s

As the colour sensor may need some time to decode the colour correctly (e.g. 14 ms) and reading may not be synchronised with the transmission, the colour may need to be maintained for a duration of 70 ms. The sequence transmitted may then be:

000001111122222000002222211111222225555500000555552222200000 22222111116666611111333331111122222

That sequence might be erroneously received as

000041111122220000002222311111222222555400000555552222200000 22222111116666611111333351111122222

In some transitions the colour decoded is not the correct one. In the worst case, 3 identical colours are going be decoded so any colour seen at the transition between digits is not going to be considered. According to that, the sequence received will be:

0120212505202161312

Depending on the mobile device's capabilities (for example, having or not Bluetooth Low Energy, e.g. BLE 4.2) and the operating system (for example, Android OS older than 6.0 or other operating system) two procedures to setup a communication may be defined, one using classical Bluetooth and another one using Bluetooth Low Energy.

Using older Bluetooth the parameters sent by light may be the procedure type, the MAC Address and the Encryption KEY. For example:

Procedure type: 1
MAC Address: 0xbcf5ac872046
Encryption KEY: 0x688596bd

Once the vending machine knows the encryption key and the MAC address of the mobile device it may initiate or accept a procedure to pair the two devices without the user intervention and establish a serial port communication (SSP) on top of the secure Bluetooth link created. At this point the mobile device and the payment system may have established a secure serial communication.

Using Bluetooth Low Energy the parameters sent by light may be the procedure type, the advertisement payload and the encryption key. For example:

Procedure type: 2
Advertisement Payload: 0x4cf53c87a04b
Encryption KEY: 0x688596bd

Once the vending machine receives the advertisement payload it may use it as part of the key in the Bluetooth Low Energy advert message the vending machine may be transmitting. This may be recognized by the mobile device and it may start setting up a connection. The mobile device may ask for a serial port on top of the Bluetooth Low Energy and establish a communication, protecting the communication with the encryption key provided.

FIG. 4 illustrates a vending scenario according to an example. A mobile device prepares a colour coded sequence of digits comprising the operating system, an advertisement payload and an encryption key and transmits it using the display to the vending machine. The vending machine may be equipped with photo-receptors and may use a Bluetooth Low Energy protocol. The vending machine 405 may then send an advertise LE signal to the mobile device 410. The mobile device 410 may receive the advertise LE signal and send a Pair to Advertisement signal to the vending machine 405. Then any Serial Port Profile Low Energy (SPPLE) Services may be discovered. Then a communication may start and the vending machine may send a payment request through the mobile device to the mobile device owner's associated payment network 415 that may retrieve funds from e.g. a bank account of the user. The communication may end when the vending machine receives the payment and the article is released to the user.

FIG. 5 illustrates a vending scenario according to another example. A user intending to buy an article, e.g. from a vending machine 505, receives an authentication from a payment network 515 associated with the user. The authentication may be received at the mobile device 510 of the user. Then the mobile device 510 may prepare a colour coded sequence of digits. The mobile device may comprise an app and the sequence of digits may comprise the operating system (OS), the MAC address of the mobile device and an encryption key (KEY). In this scenario a classical Bluetooth connection is anticipated. Then the colour coded sequence of digits may be transmitted to the vending machine. The vending machine may comprise a light-sensor and a communication module (e.g. a Bluetooth module). Once the colour coded sequence of digits is received and decoded, the vending machine may initiate a pairing process using the MAC address included in the sequence of digits. The mobile device may then open an SPP port and then the communication between vending machine and mobile device may begin. The vending machine may then send a payment request to the mobile device owner's associated payment network 515 that may retrieve funds from e.g. a bank account 520 of the user.

Alternatively, the vending machine may send the payment request to the payment network without the need for the user to authenticate. This may be the case if the user has previously authorized the bank to e.g. accept small payment requests.

The communication may end when the vending machine receives the payment and the article is released to the user.

Although only a number of particular embodiments and examples have been disclosed herein, it will be understood by those skilled in the art that other alternative embodiments and/or uses and obvious modifications and equivalents thereof are possible. Furthermore, the disclosure covers all possible combinations of the particular embodiments described. Thus, the scope of the disclosure should not be limited by particular embodiments.

Further, although the examples described with reference to the drawings comprise computing apparatus/systems and processes performed in computing apparatus/systems, the disclosure also extends to computer programs, particularly computer programs on or in a carrier, adapted for putting the system into practice.

1. A method of securely communicating a color encoded sequence of digits from a display of a mobile device to a photo-receptor device, comprising:
preparing the color encoded sequence of digits at the mobile device;
identifying proximity of the photo-receptor device;
presenting the color encoded sequence of digits at the display in the form of light flashes;
receiving confirmation of reception of the color encoded sequence of digits at the photo-receptor device; and
receiving confirmation of decoding of the sequence of digits at the photo-receptor device.

2. The method according to claim 1, further comprising initiating a pairing connection between the mobile device and the photo-receptor device once the decoding is successful.

3. The method according to claim 2, wherein the pairing connection is a wireless connection.

4. The method according to claim 3, wherein the wireless connection is a Bluetooth connection.

5. The method according to claim 3, wherein the wireless connection is a Wi-Fi connection.

6. The method according to claim 2, wherein the pairing connection is a cable connection.

7. The method according to claim 1, further comprising sending an actuation instruction on an access module once the decoding takes place.

8. The method according to claim 7, wherein the access module is a structure controlling access to a controlled space.

9. The method according to claim 8, wherein the access module is a lock.

10. The method according to claim 2, further comprising performing a transaction once the pairing is successful.

11. The method according to claim 10, further comprising
sending a request to release a product or a service;
facilitating a secure communication between the photo-receptor device and a remote financial entity to confirm that the request is a valid request; and
receiving a confirmation of releasing the product or service when the request is validated.

12. The method according to claim 11, wherein the communication between the photo-receptor device and the third party financial entity is implemented through the paired mobile device.

13.-35. (canceled)

36. A mobile device to communicate a color encoded sequence of digits to a photo-receptor device, comprising,
a communication module;
a color encoding module to receive a sequence of digits and generate a color encoded sequence corresponding to the received sequence of digits; and
a display to present the color encoded sequence to the photo-receptor device in the form of light flashes.

37. The mobile device according to claim 36, the communication module to initiate a pairing connection with the photo-receptor device.

38. The mobile device according to claim 36, further comprising one or more sensors to identify placement of the display against the photo-receptor device.

39. The mobile device according to claim 36, wherein the one or more sensors comprises one or more of an accelerometer, a proximity sensor, a magnetometer, a light intensity sensor an orientation sensor and an haptic or touch sensor.

40. A photo-receptor device to receive a color encoded sequence of digits from a mobile device in the form of light flashes, comprising:
one or more optical sensors, to receive a color encoded sequence from a mobile device; and
a decoder, to decode the color encoded sequence and generate a sequence of bits.

41. The photo-receptor device according to claim 40, further comprising a communication module to initiate a pair connection with the mobile device when the color encoded sequence is decoded.

42. The photo-receptor device according to claim 41, comprising a vending device.

43. The photo-receptor device according to claim 42, the vending device comprises a full-line vending device.

44.-53. (canceled)
